(19) United States
(12) Patent Application Publication
(10) Pub. No.: US 2022/0131864 A1
(43) Pub. Date: Apr. 28, 2022

(54) METHOD AND SYSTEM FOR ESTABLISHING APPLICATION WHITELISTING

(71) Applicant: INDUSTRIAL TECHNOLOGY RESEARCH INSTITUTE, HSINCHU (TW)

(72) Inventors: Dmitry SHERSTOBOEV, Zhudong Township (TW); Tzi-Cker CHIUEH, Taipei City (TW); Ming-Gu YANG, Hsinchu City (TW)

(73) Assignee: INDUSTRIAL TECHNOLOGY RESEARCH INSTITUTE, HSINCHU (TW)

(21) Appl. No.: 17/082,581

(22) Filed: Oct. 28, 2020

(51) Int. Cl. H04L 29/06

(52) U.S. Cl. CPC H04L 63/101; H04L 69/163; H04L 63/0263; H04L 63/1425

(57) ABSTRACT

A method for establishing application whitelisting includes: collecting inter-thread traffic logs sent from at least one server, wherein a plurality of distributed applications are hosted in the at least one server; discovering topology information in a green room environment based on the inter-thread traffic logs; creating a set of whitelisting rules based on the topology information; and enforcing the set of whitelisting rules.

### TECHNICAL FIELD

The disclosure relates in general to a method and a system for establishing application whitelisting.

### BACKGROUND

Recently the topic of network security becoming more and more important. With the increasing amount of distributed applications hosted in the data centers, the need for automatic malware and intrusion detection is growing. Application whitelisting recently has mostly been human-defined, while in distributed applications consisting of thousands of nodes, the important way is to create an automatic system for creating such rules.

A distributed application is software that is executed or run on multiple computers within a network. These distributed applications interact in order to achieve a specific goal or task. Traditional applications relied on a single system to run them. Even in the client-server model, the application software had to run on either the client, or on the server that the client was accessing.

A whitelist is a list of items that are granted access to a certain system or protocol. When a whitelist is used, all entities are denied access, except those included in the whitelist. Traditionally whitelists are defined by the system administrator. While it is working well for the small systems and distributed applications, with the increase of nodes it is much easier to make a mistake or miss one of the rules which will lead to the application malfunctioning.

### SUMMARY

The disclosure is directed to a method and a system for distributed application whitelisting using topology information.

According to one embodiment, a method for establishing application whitelisting includes: collecting inter-thread traffic logs sent from at least one server, wherein a plurality of distributed applications are hosted in the at least one server; discovering topology information in a green room environment based on the inter-thread traffic logs; creating a set of whitelisting rules based on the topology information; and enforcing the set of whitelisting rules.

According to another embodiment, a system for establishing application whitelisting includes: at least one server, wherein a plurality of distributed applications are hosted in the at least one server; and an analytic engine coupled to the at least one server for collecting inter-thread traffic logs sent from the at least one server. The analytic engine is configured for: discovering topology information in a green room environment based on the inter-thread traffic logs; creating a set of whitelisting rules based on the topology information; and enforcing the set of whitelisting rules.

### BRIEF DESCRIPTION OF THE DRAWINGS

FIG. 1 shows a block diagram illustrating a system for establishing application whitelisting according to one embodiment of the application.

FIG. 2 shows a flow chart illustrating a method for establishing application whitelisting according to one embodiment of the application.

FIG. 3 shows a flow chart of building application dependency map (ADM) in one embodiment of the application.

FIG. 4A shows an example of a green room ADM in one embodiment of the application.

FIG. 4B shows an example of a real operation ADM in one embodiment of the application.

FIG. 4C shows an example of another real operation ADM in one embodiment of the application.

FIG. 5 shows a flow chart of enforcing the whitelisting rules while are minimizing false-positive alarms in one embodiment of the application.

FIG. 6A and FIG. 6B shows how to determine whether the green room ADM and the real operation ADM are equivalent by determining whether the incomplete edge is legitimate or not.

FIG. 7 shows an attack determination according to one embodiment of the application.

FIG. 8 shows a situation that the connection is later confirmed as validity and thus the valid connection is used to update the green room ADM.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

In embodiments of the application, the method and the system relates to an automatic approach of defining whitelisting rules and threat levels for distributed application system. In embodiments of the application, the method and the system relates for discovering distributed application dependency map. In embodiments of the application, the method and the system relates for converting dependency map into the set of whitelisting rules. In embodiments of the application, the method and the system relates for enforcing whitelisting rules focusing on reducing false-positives.

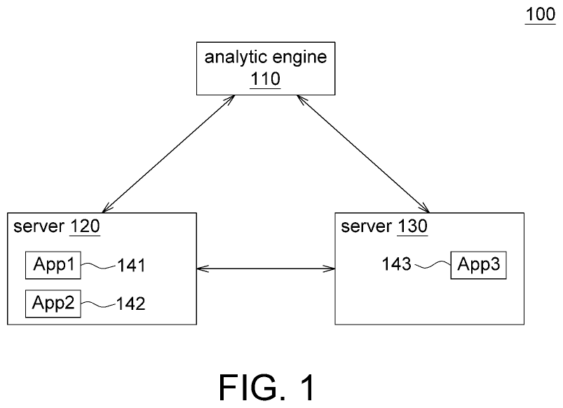

FIG. 1 shows a block diagram illustrating a system for establishing application whitelisting according to one embodiment of the application. The system 100 includes an analytic engine 110 and at least one server (for example but not limited by, two servers 120 and 130) coupled to the analytic engine 110. At least one distributed application is hosted in the server 120; and at least one distributed application is hosted in the server 130. For example but not limited by, applications 141 and 142 are hosted in the server 120; while an application 143 is hosted in the server 130.

The analytic engine 110 collects inter-thread traffic logs sent from the servers 120 and 130. The inter-thread traffic logs records thread traffic about execution of the applications 141, 142 and 143.

In one embodiment of the application, the analytic engine 110 analyzes the inter-thread traffic logs to execute three stages process: discovering topology information (topology information being for example but not limited by application dependency mapping (ADM)) in the green room environment based on the inter-thread traffic logs; creating a set of whitelisting rules based on the topology information or the green room ADM; and enforcing the set of the whitelisting rules while minimizing false-positive alarms. Green room environment denotes an isolated and secured working space with access control. The space is clean free from attacks of malware and virus. In the space we are able to collect nominal behaviors of applications to establish ground truth for application whitelisting.

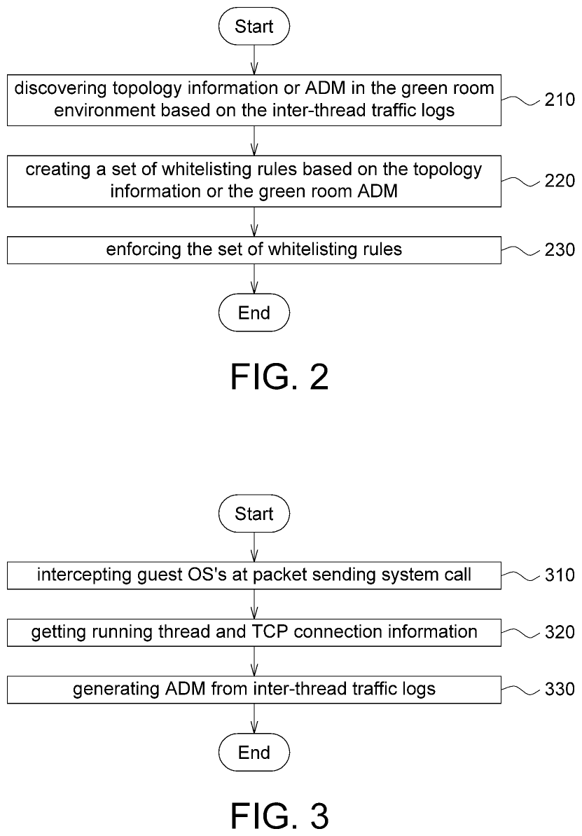

FIG. 2 shows a flow chart illustrating a method for establishing application whitelisting according to one embodiment of the application. In step 210, topology information or ADM in the green room environment is discovered based on the inter-thread traffic logs. In step 220, a set of whitelisting rules is created based on the topology information or the green room ADM. In step 230, the set of whitelisting rules are enforced while false-positive alarms are minimized.

Application dependency mapping (ADM) creates relationships between interdependent applications. ADM identifies: a plurality of devices (for example, the servers 120 and 130) that are communicating with one another; the TCP IP ports these devices use for communication; and the processes that are running on these devices.

FIG. 3 shows a flow chart of building ADM in one embodiment of the application. In step 310, guest OS's are intercepted at packet sending system call. In step 320, running thread and TCP connection (source TCP IP Port, destination TCP IP Port) information are got. In step 330, accurate application dependency map (ADM) is generated from inter-thread traffic logs.

One approach in one embodiment of the application looks into the thread-level execution of the connections. The interception at system call enables detection and deployment of changes. Logging the traffic at inter-thread level ensures the generation of accurate application dependencies.

Following explains how to create a set of whitelisting rules by converting the ADM into the set of whitelisting rules in one embodiment of the application. For each record in the application dependency map, one embodiment of the application creates a firewall rule (a set of whitelisting rules) including a plurality of nodes each having attribute including an application name information and a destination port information.

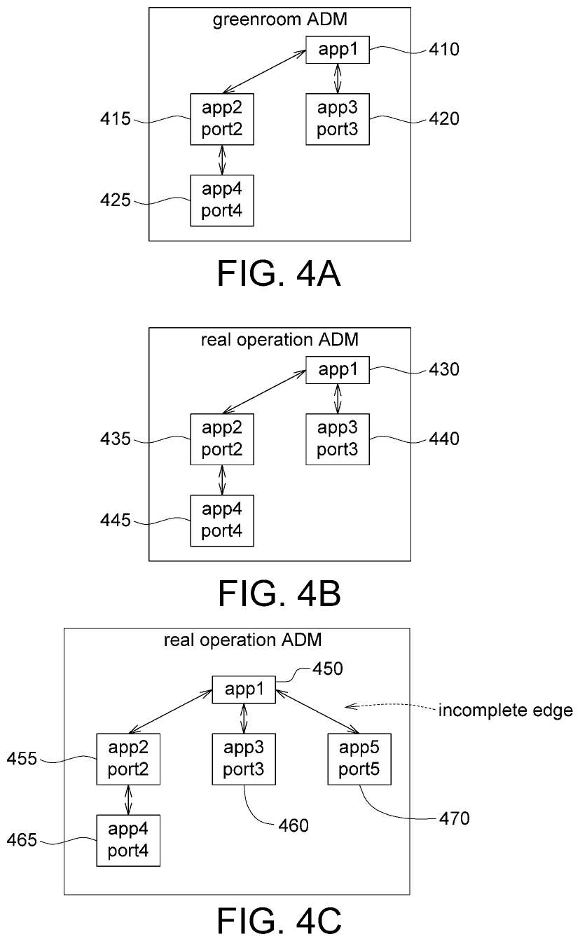

FIG. 4A shows an example of a green room ADM in one embodiment of the application. FIG. 4B shows an example of a real operation ADM in one embodiment of the application. FIG. 4C shows an example of another real operation ADM in one embodiment of the application. The green room ADM is the ADM defined or generated in the green room while the real operation ADM is the ADM defined or generated in the real operation.

As shown in FIG. 4A, the green room ADM includes the nodes 410-425, wherein the attribute of each node includes an application name information and a destination port information. For example, the attribute of the node 410 includes the application name information (i.e. app1) and the destination port information (N/A), while the attribute of the node 415 includes the application name information (i.e. app2) and the destination port information (i.e. port 2). The attributes of the nodes 430-445 and 450-470 in FIG. 4B and FIG. 4C are similar.

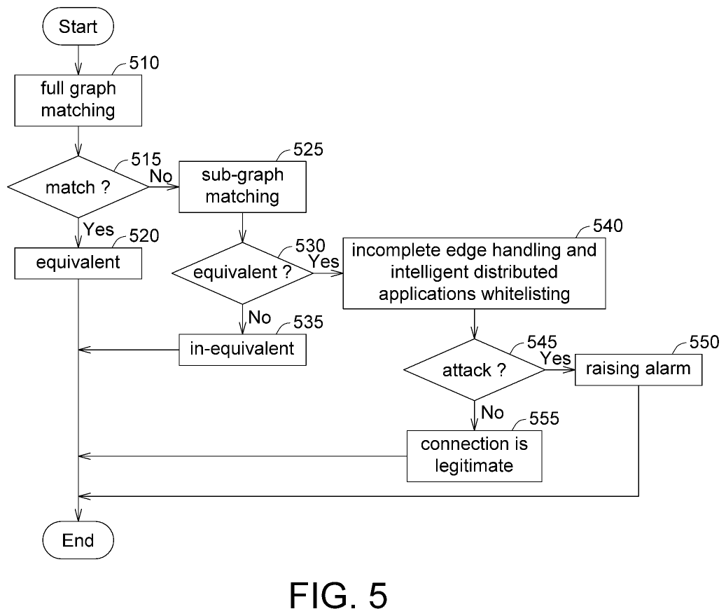

FIG. 5 shows a flow chart of enforcing the whitelisting rules while are minimizing false-positive alarms in one embodiment of the application. In comparing the ADM in a green room environment with the real operation ADM, the real operation ADM might be different, most noticeably each node IP address will change, but the application name information and the destination port information stay the same. In that case, it needs to perform full graph matching in one embodiment of the application.

About whitelisting rules enforcement, after the original whitelisting rules are modified to match the distributed application in the production environment (in the real operation), the embodiment of the application starts blocking each connection that is not on the white list. When some of the connections are blocked, there could be two cases: the connection is trustworthy but this is not seen during the green room environment observation.

This could be some rare occurring event, e.g. monthly backup. Another case is when the connection is not trustworthy, such cases can occur when malware is present in the system.

In step 510, a full graph matching is performed by comparing the green room ADM with the real operation ADM. In step 515, based on the comparison result, it is determined whether the green room ADM is matched with the real operation ADM or not.

For example, by comparing the green room ADM in FIG. 4A with the real operation ADM in FIG. 4B, then it is determined that they are matched. On the contrary, by comparing the green room ADM in FIG. 4A with the real operation ADM in FIG. 4C, then it is determined that they are not matched.

In details, in comparing the green room ADM with the real operation ADM, each node in the ADM is compared. In comparing the green room ADM in FIG. 4A with the real operation ADM in FIG. 4B, the nodes 410-425 of the green room ADM are compared with the nodes 430-445 of the real operation ADM, respectively, by comparing the attributes of the nodes 410-425 of the green room ADM with the attributes of the nodes 430-445 of the real operation ADM. After comparison, when the attributes of the nodes 410-425 are the same with the attributes of the nodes 430-445, it is determined that the nodes 410-425 of the green room ADM in FIG. 4A are equivalent with the nodes 430-445 of the real operation ADM in FIG. 4B and thus it is determined that the green room ADM in FIG. 4A are matched with the real operation ADM in FIG. 4B.

On the contrary, in comparing the green room ADM in FIG. 4A with the real operation ADM in FIG. 4C, the nodes 410-425 of the green room ADM are compared with the nodes 450-470 of the real operation ADM, respectively, by comparing the attributes of the nodes 410-425 of the green room ADM with the attributes of the nodes 450-470 of the real operation ADM. After comparison, it is determined that the node 470 (whose attribute including the application name information (i.e. app5) and the destination port information (port 5)) of the real operation ADM does not match with any node in the green room ADM. Thus, it is determined that the green room ADM in FIG. 4A does not match with the real operation ADM in FIG. 4C.

In step 515, when it is determined that the green room ADM is matched with the real operation ADM, the flow determines that the green room and the real operation ADM are equivalent (i.e. no false-positives) in step 520. By so, no false-positive errors and no false-negative errors occur in the embodiment of the application. In the application, a false positive error is an event that the system in one embodiment of the application identifies as an attack when in fact it isn't; and a false negative error is an event that the system in one embodiment of the application identifies as legitimate when it fact it isn't.

In step 515, when it is determined that the green room ADM is not matched with the real operation ADM, the flow goes to step 525. In step 525, a sub-graph matching is performed on the green room ADM and the real operation ADM to find any incomplete edge of the real operation ADM. For example, in step 525, the sub-graph matching is performed on the green room ADM in FIG. 4A and the real operation ADM in FIG. 4C to find the incomplete edge (i.e. the node 470) of the real operation ADM.

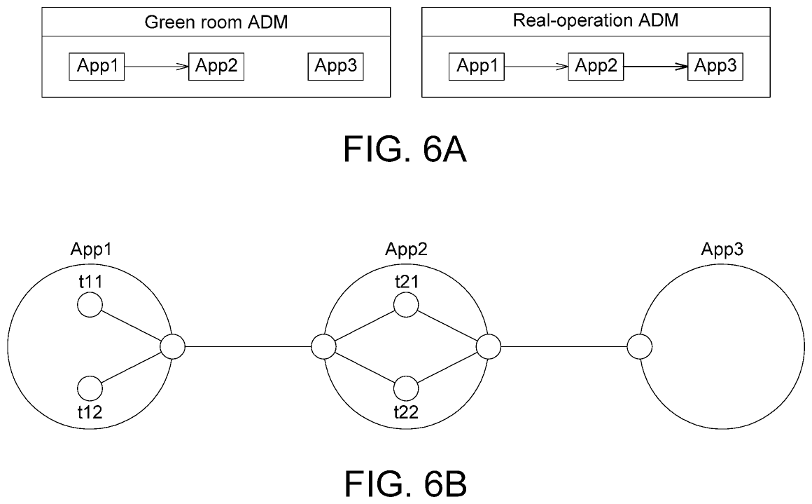

In step 530, it is determined whether the green room ADM and the real operation ADM are equivalent by determining whether the incomplete edge is legitimate or not. FIG. 6A and FIG. 6B shows how to determine whether the green room ADM and the real operation ADM are equivalent by determining whether the incomplete edge is legitimate or not. For example, as shown in FIG. 6A, after comparing the green room ADM with the real operation ADM, it is found the connection between the application app2 and the application app3 is an incomplete edge. As shown in FIG. 6B, when the connection between the application app1 and the application app2 goes through from the thread t11 of the application app1 to the thread t21 of the application app2 and the connection between the application app2 and the application app3 goes through from the thread t22 of the application app2 to the application app3, then it is determined that the connection between the application app2 and the application app3 is not legitimate because the connections in the application app2 are not on the same thread (t21).

As shown in FIG. 6B, when the connection between the application app1 and the application app2 goes through from the thread t11 of the application app1 to the thread t21 of the application app2 and the connection between the application app2 and the application app3 goes through from the thread t21 of the application app2 to the application app3, then it is determined that the connection between the application app2 and the application app3 is legitimate because the connections in the application app2 are on the same thread (t21).

That is to say, in one embodiment of the application, even though a connection request (for example, from the application app2 to the application app3) is not on the original topology (for example but not limited by, the green room ADM) but the connection is made on the same thread in the application app2 after receiving connection request (for example, from the application app1 to the application app2), it is allowed. Thus, whether the connection request is allowed or not is based on whether the connection is made on the same thread or not.

When it is determined that the green room ADM and the real operation ADM are not equivalent by determining that the incomplete edge is not legitimate in step 530, the flow goes to step 535 to decide that the green room ADM and the real operation ADM are in-equivalent (i.e. the real operation ADM are not legitimate).

On the contrary, when it is determined that the green room ADM and the real operation ADM are equivalent by determining that the incomplete edge is legitimate in step 530, the flow goes to step 540 to perform incomplete edge handling to update the green room ADM based on the legitimate incomplete edge and intelligent distributed applications whitelisting based on the green room ADM.

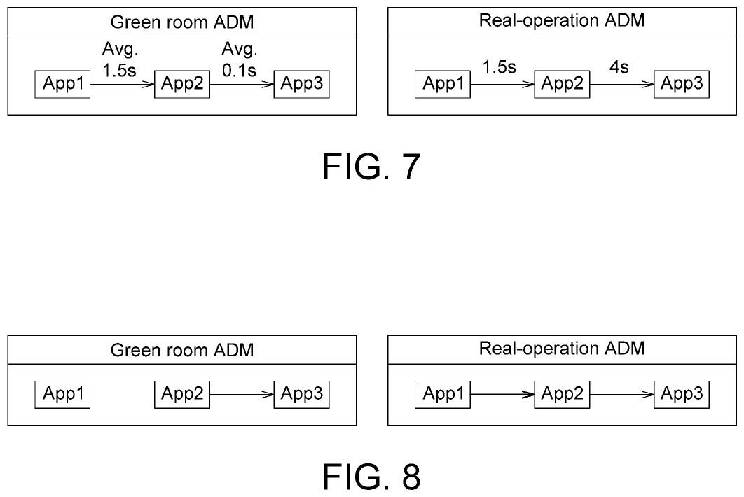

In step 545, whether it is an attack is determined. FIG. 7 shows an attack determination according to one embodiment of the application. As shown in FIG. 7, in green room ADM, the connection between the application app1 and the application app2 is averaged about 1.5 seconds; and the connection between the application app2 and the application app3 is averaged about 1.5 seconds. However, in real operation room ADM, the connection between the application app1 and the application app2 is about 1.5 seconds; and the connection between the application app2 and the application app3 is about 4 seconds. Because the connection request between the application app2 and the application app3 took much longer than usual, it might be suspicious activity, for which an alarm is raised in step 550. In other words, in determining whether there is an attack or not based on a time period for a connection request, an alarm for suspicious activity is raised.

On the contrary, when it is determined that the connection is not an attack in step 545, the flow goes to step 555 to identify the connection is legitimate and the green room ADM is updated.

In one embodiment of the application, it allows some communications outside of whitelist to go through and later confirms their validity by determining whether they are on the same thread, e.g., if seemingly not legitimate communication from the application app1 to the application app2 is followed by a legitimate communication from the application app2 to the application app3. FIG. 8 shows a situation that the connection between the application app1 to the application app2 is later confirmed as validity and thus the valid connection between the application app1 to the application app2 is used to update the green room ADM.

The purpose of embodiments of the application is to provide an automatic security system that allows certain network connections that are considered legal while others are examined first and depending on the threat level to determine whether the network connections are either blocked, allowed, or whether to trigger the alarm. The main focus of embodiments of the application is to reduce both human interactions with the system as well as false-positive errors.

In brief, in embodiments of the application, a distributed application is software that runs across multiple computers within a network at the same time and can be stored on servers or with cloud computing. A distributed application is first examined in the green room environment to determine the relationship between each node of the applications. The topology and application dependency map (ADM) are formed using gathered information. Using the application dependency map (ADM), a set of whitelisting rules are formed to enforce only valid connections. This information is later used when a distributed application is placed in the real environment. The application dependency map (ADM) is used to identify each node of the distributed application. After each node is identified, a set of rules are whitelisting modified to match the new environment (the real operation). When there is a new connection that is not originally discovered in the green room environment, the application dependency map (ADM) is used to measure its validity. If the new connection is determined as being validity, the new connection is used to update the green room ADM.

The application introduces an automatic system for both whitelisting rules creation and enforcement. The application is to automate not only whitelisting rules creation but also introduce smart whitelisting rules enforcement, where not every single connection outside of whitelist is blocked, but rather examined first and the threat level is identified.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for establishing application whitelisting comprising:
collecting inter-thread traffic logs sent from at least one server, wherein a plurality of distributed applications are hosted in the at least one server;
discovering topology information in a green room environment based on the inter-thread traffic logs;
creating a set of whitelisting rules based on the topology information; and
enforcing the set of whitelisting rules.

2. The method according to claim 1, wherein the topology information includes an application dependency mapping (ADM);
the ADM creates relationships between the distributed applications hosted in the servers; and
the ADM identifies: a plurality of devices that are communicating with one another; TCP IP ports the devices use for communication; and processes that are running on these devices.

3. The method according to claim 2, wherein building the ADM includes:
intercepting guest OS's at packet sending system call;
getting running thread and TCP connection information; and
generating the ADM from the inter-thread traffic logs.

4. The method according to claim 2, wherein in creating the set of whitelisting rules, for each record in the ADM, the set of whitelisting rules includes a plurality of nodes each having attribute including an application name information and a destination port information.

5. The method according to claim 4, wherein enforcing the set of whitelisting rules includes:
performing a full graph matching by comparing a green room ADM with a real operation ADM; and
based on a comparison result, determining whether the green room ADM is matched with the real operation ADM or not.

6. The method according to claim 5, wherein in comparing the green room ADM with the real operation ADM, a plurality of nodes of the green room ADM are compared with a plurality of nodes of the real operation ADM, respectively, by comparing attributes of the nodes of the green room ADM with attributes of the nodes of the real operation ADM.

7. The method according to claim 6, wherein
when the green room ADM is matched with the real operation ADM, the green room ADM and the real operation ADM are equivalent; and
when the green room ADM is not matched with the real operation ADM, a sub-graph matching is performed on the green room ADM and the real operation ADM to find any incomplete edge of the real operation ADM.

8. The method according to claim 7, wherein in the sub-graph matching, it is determined whether the green room ADM and the real operation ADM are equivalent by determining whether the incomplete edge of the real operation ADM is legitimate or not based on whether connection is made on a same thread or not.

9. The method according to claim 8, wherein
when it is determined that the green room ADM and the real operation ADM are not equivalent in the sub-graph matching by determining that the incomplete edge is not legitimate, it is determined that the real operation ADM are not legitimate; and
when it is determined that the green room ADM and the real operation ADM are equivalent in the sub-graph matching by determining that the incomplete edge is legitimate, performing incomplete edge handling to update the green room ADM based on the incomplete edge and performing intelligent distributed applications whitelisting based on the green room ADM.

10. The method according to claim 9, wherein in determining whether there is an attack or not based on a time period for a connection request, an alarm for suspicious activity is raised; and upon determining that the connection request is not an attack, it is identified that the connection request is legitimate and the green room ADM is updated.

11. A system for establishing application whitelisting comprising:
at least one server, wherein a plurality of distributed applications are hosted in the at least one server; and
an analytic engine coupled to the at least one server for collecting inter-thread traffic logs sent from the at least one server;
wherein the analytic engine is configured for:
discovering topology information in a green room environment based on the inter-thread traffic logs;
creating a set of whitelisting rules based on the topology information; and
enforcing the set of whitelisting rules.

12. The system according to claim 11, wherein
the topology information includes an application dependency mapping (ADM);
the ADM creates relationships between the distributed applications hosted in the servers; and
the ADM identifies: a plurality of devices that are communicating with one another; TCP IP ports the devices use for communication; and processes that are running on these devices.

13. The system according to claim 12, wherein the analytic engine is configured for building the ADM by:
intercepting guest OS's at packet sending system call;
getting running thread and TCP connection information; and
generating the ADM from the inter-thread traffic logs.

14. The system according to claim 12, wherein in creating the set of whitelisting rules, for each record in the ADM, the set of whitelisting rules includes a plurality of nodes each having attribute including an application name information and a destination port information.

15. The system according to claim 14, wherein the analytic engine is configured for enforcing the set of whitelisting rules by:
performing a full graph matching by comparing a green room ADM with a real operation ADM; and
based on a comparison result, determining whether the green room ADM is matched with the real operation ADM or not.

16. The system according to claim 15, wherein the analytic engine is configured for
in comparing the green room ADM with the real operation ADM, comparing a plurality of nodes of the green room ADM with a plurality of nodes of the real operation ADM, respectively, by comparing attributes of the nodes of the green room ADM with attributes of the nodes of the real operation ADM.

17. The system according to claim 16, wherein the analytic engine is configured for
when the green room ADM is matched with the real operation ADM, determining that the green room ADM and the real operation ADM are equivalent; and
when the green room ADM is not matched with the real operation ADM, performing a sub-graph matching on the green room ADM and the real operation ADM to find any incomplete edge of the real operation ADM.

18. The system according to claim 17, wherein the analytic engine is configured for
in the sub-graph matching, determining whether the green room ADM and the real operation ADM are equivalent by determining whether the incomplete edge of the real operation ADM is legitimate or not based on whether connection is made on a same thread or not.

19. The system according to claim 18, wherein the analytic engine is configured for
when the green room ADM and the real operation ADM are not equivalent in the sub-graph matching by determining that the incomplete edge is not legitimate, determining that the real operation ADM are not legitimate; and
when that the green room ADM and the real operation ADM are equivalent in the sub-graph matching by determining that the incomplete edge is legitimate, performing incomplete edge handling to update the green room ADM based on the incomplete edge and performing intelligent distributed applications whitelisting based on the green room ADM.

20. The system according to claim 19, wherein the analytic engine is configured for
in determining whether there is an attack or not based on a time period for a connection request, raising an alarm for suspicious activity; and
when determining the connection request is not an attack, it is identified that the connection request is legitimate and updating the green room ADM.
